(19) United States
(12) Patent Application Publication
(10) Pub. No.: US 2004/0095931 A1
(43) Pub. Date: May 20, 2004

(54) Method and apparatus for frame transfer

(76) Inventor: Tsutomu Noguchi, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/694,691

(22) Filed: Oct. 28, 2003

(30) Foreign Application Priority Data
Oct. 29, 2002 (JP) 2002-314498

(51) Int. Cl. H04L 12/28

(52) U.S. Cl. 370/389

(57) ABSTRACT

In a method and an apparatus for frame transfer which can flexibly and individually set a normally-transferred frame and a monitored frame, the monitored frame having unique in-device information and the normally-transferred frame are generated from a received frame, and then a path is established corresponding to these frames. Also, the same local switch is arranged on both sides of a network processor, a monitoring function is realized by looping back a frame determined to be monitored in the network processor to the network processor through the local switch, and two frames looped back to the network processor are respectively processed into the normally-transferred frame and a CPU-transferred frame to be transferred to the switch portion.

### BACKGROUND OF THE INVENTION

1. Field of the Invention

The present invention relates to a method and an apparatus for frame transfer, and in particular to a method and an apparatus for loop transferring and monitoring frames or packets (hereinafter, generally represented by frames) received from a line.

In an IP router or the like, when a network manager monitors the contents of information passing through a router, a received frame which is to be monitored is copied upon loop transferring (normal transferring) and this copied frame is transferred to a CPU or the like connected to the router, thereby realizing a frame monitoring function.

2. Description of the Related Art

FIG. 5 shows a prior art example (1) of a method and an apparatus for realizing the above-mentioned frame transfer. In FIG. 5, the frame transfer apparatus is composed of line terminals 1_0-1_N (hereinafter, occasionally represented by a reference numeral “1”), frame processors 2_0-2_N (hereinafter, occasionally represented by a reference numeral “2”), and a switch portion (switching LSI) 3.

The operation of such a frame transfer apparatus will now be described as well as referring to FIG. 6. Signal terminal processing at a physical layer is performed to a frame received from an external line by a physical layer processor (PHY) 10 in e.g. the line terminal 1_0, as shown in FIG. 5, to be transmitted to the frame processor 2.

The frame processor 2 is composed of a network processor NP1, a local switch LSW, and a network processor NP2 all connected in series.

In the frame processor 2, layer 2 (L2) processing is firstly performed to a frame FR11 (header information HD11+payload information PL) from the line terminal 1_0 at the network processor NP1. Then, buffering and predetermined switching, to a multicast queue described later, are performed to the frame FR11 at the local switch LSW to be transmitted to the network processor NP2.

At the network processor NP2, layer 3 (L3) processing is performed. Namely, normal IP processing (IP header check/change processing, routing search processing, and filtering search processing) is performed to the received frame in cooperation with a search processor (see FIG. 2).

When the received frame has e.g. a predetermined destination address within header information, the network processor NP2 determines that this frame is to be monitored, and generates a frame FR12 including an ID (or flag) to be monitored as header information HD12 (see (1) in FIG. 5).

The frame FR12 to which the monitored ID is assigned in this way is transmitted to the switch portion 3, and then it is copied (see (2) in FIG. 5) by multicast processing MC at a multicast queue 31 within a crossbar switch 30 already designated by the local switch LSW.

As a result, a normally-transferred frame FR13 including a normally-transferred ID, which is an ID for establishing a path at the switch portion 3 but is different from the ID in the header information HD11, in header information HD13 is transmitted to the frame processor 2_1 from the multicast queue 31, while at the same time a CPU-transferred frame FR14 including a CPU-transferred ID in header information HD14 is transmitted to a CPU (not shown), as disclosed in e.g. patent document 1.

FIG. 7 shows a prior art example (2) of the frame transfer apparatus. This prior art example (2) is different from the prior art example (1) in that dedicated devices 31_0-31_N (hereinafter, occasionally represented by a reference numeral “31”) are substituted for a multicasting function in the switch portion 3.

Namely, in the same way as the prior art example (1), the switch portion 3 which has received the frame FR12 in which the monitored ID is assigned to the header information HD12 at the network processor NP2 in the frame processor 2_0 copies a frame which is transferred to the CPU for the monitored frame FR12 at the dedicated device 31_0 (see (2) in FIG. 7).

Then, the normally-transferred frame FR13 is transmitted from the dedicated device 31_1 to the frame processor 2_1, and the CPU-transferred frame FR14 is transmitted to the CPU.

Patent Document 1:

Japanese Patent Application Laid-open No.10-154989 (abstract and FIG. 3)

In case of the prior art example (1) shown in FIG. 5, a frame is copied by using the multicasting function of the switching LSI in the switch portion 3, and processing is performed to the frame as a multicast frame to be transferred to the CPU. Therefore, even if the frame is a unicast frame, it becomes a multicast frame, so that it becomes difficult to perform a control (QoS or the like) with discrimination between unicast and multicast.

Also, since the switch portion 3 has to prepare both connections (paths) for normally-transferred frames and monitored frames respectively, many connections are required and the management becomes complicated.

On the other hand, in case of the prior art example (2) shown in FIG. 7, the dedicated device except the switching LSI composing the switch portion 3 copies the frames, which leads to an increase in cost and a reduced mounting area of the device.

Furthermore, while both of the above-mentioned prior art examples (1) and (2) have a frame copying function, editing frame information can not be performed in the frame processor 2 and the switch portion 3. Therefore, there has been a problem that the format of the normally-transferred frame FR13 becomes similar to that of the CPU-transferred frame FR14 as shown in FIG. 6, and unique frame information (in-device information) can not be set for each frame, resulting in a poor flexibility.

### SUMMARY OF THE INVENTION

It is accordingly an object of the present invention to provide a method and an apparatus for frame transfer which can flexibly and individually set normally-transferred frames and monitored frames, preferably to realize frame transfer in which connection management is easy to be performed without awareness of a unicast/multicast, and more preferably to realize an inexpensive copying function without using dedicated devices.

In order to achieve the above-mentioned object, a frame transfer method comprises: a first step of generating, from a received frame, a monitored frame having unique in-device information and a normally-transferred frame; and a second step of establishing a path corresponding to each of the generated frames.

Namely, in the present invention, a monitored frame having unique in-device information different from a normally-transferred frame is generated from a received frame at the first step, and a path corresponding to each frame is established at the second step.

Accordingly, it is possible to flexibly and individually set the normally-transferred frame and the monitored frame with regard to QoS or the like. It is to be noted that the in-device information has only to be assigned to at least the monitored frame among the monitored frame and the normally-transferred frame.

The above-mentioned first step may comprise a third step of determining whether or not the received frame is to be monitored and of generating, from the received frame, a dual-purpose normally-transferred and monitored frame, and a fourth step of generating, from the dual-purpose frame, the monitored frame and the normally-transferred frame.

The above-mentioned third step may include steps of determining whether or not the received frame is to be monitored, and generating the dual-purpose frame in which predetermined header information is substituted for header information of the received frame when determining that the received frame is to be monitored, and the fourth step may include steps of multicasting the dual-purpose frame to be outputted by editing header information of one of the multicasted frames for normal transferring and header information of the other frame for monitoring, and further editing both of the multicasted frames with header information respectively corresponding thereto for the second step.

Also, the above-mentioned predetermined header information of the dual-purpose frame may include a monitored ID as well as information necessary for restoring a normally-transferred ID and information used for monitoring, and the fourth step may include steps of generating two frames in which the monitored ID of the dual-purpose frame is rewritten into an original flag and a monitored flag upon the multicasting, and further generating the normally-transferred frame and the monitored frame respectively by restoring a normally-transferred ID for header information of the frame having the original flag and rewriting header information of the frame having the monitored flag into a CPU-transferred ID.

Furthermore, the above-mentioned third step may include a step of determining that the received frame is to be monitored based on a destination address in header information of the received frame.

An apparatus for realizing the above-mentioned frame transfer method according to the present invention comprises: a frame processor for generating, from a received frame, a normally-transferred frame and a monitored frame having unique in-device information; and a switch portion for establishing a path corresponding to each of the generated frames by inputting the frames.

Accordingly, the present invention, in the same way as the above-mentioned present invention, can flexibly and individually set the normally-transferred frame and the monitored frame with regard to the in-device information, and can realize a monitoring function without the dedicated device for the monitoring function.

As schematically shown in FIG. 1, the above-mentioned frame processor may comprise a network processor NP2 for determining whether or not the received frame is to be monitored and for generating, from the received frame, a dual-purpose normally-transferred and monitored frame FR2, and a local switch LSW for generating in cooperation with the network processor NP2, from the dual-purpose frame, the monitored frame FR6 and the normally-transferred frame FR5 to be transmitted to the switch portion.

More specifically, the network processor NP2 (1) may determine whether or not the received frame is to be monitored, and generate the dual-purpose frame FR2 in which predetermined header information is substituted for header information of the received frame when determining that the received frame is to be monitored, and the local switch LSW (2) may multicast the dual-purpose frame FR2 to be outputted to the network processor by editing header information of one of the multicasted frames FR5 for normal transferring and header information of the other frame FR6 for monitoring, and the network processor NP2 (3) may edit both of the frames FR5 and FR6 with header information respectively corresponding thereto to be transmitted to the switch portion.

Thus, since copying is performed by multicast processing at the local switch LSW, it is possible to make a transfer destination of the frame the network processor NP2, and the monitoring function can be realized without awareness of the unicast/multicast.

Also, since the network processor NP2 has only to set a single connection (destination) for loopback through the local switch LSW, the management of the connection becomes easy.

Also, the above-mentioned predetermined header information of the dual-purpose frame may include a monitored ID as well as information necessary for restoring a normally-transferred ID and information used for monitoring, and the local switch may generate two frames in which the monitored ID of the dual-purpose frame is rewritten into an original flag and a monitored flag upon the multicasting, and the network processor may generate the normally-transferred frame and the monitored frame respectively by restoring a normally-transferred ID for header information of the frame having the original flag and rewriting header information of the frame having the monitored flag into a CPU-transferred ID.

Furthermore, the above-mentioned network processor may determine that the received frame is to be monitored based on a destination address in header information of the received frame.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram for schematically illustrating a method and an apparatus for frame transfer according to the present invention;

FIG. 2 is a block diagram showing an embodiment of an apparatus realizing a frame transfer method according to the present invention;

FIG. 3 is a flow chart showing an operation example of an apparatus realizing a frame transfer method according to the present invention;

FIG. 4 is a diagram showing a generation process of frame information by an apparatus realizing a frame transfer method according to the present invention;

FIG. 5 is a block diagram showing a prior art example (1) of a method and an apparatus for frame transfer;

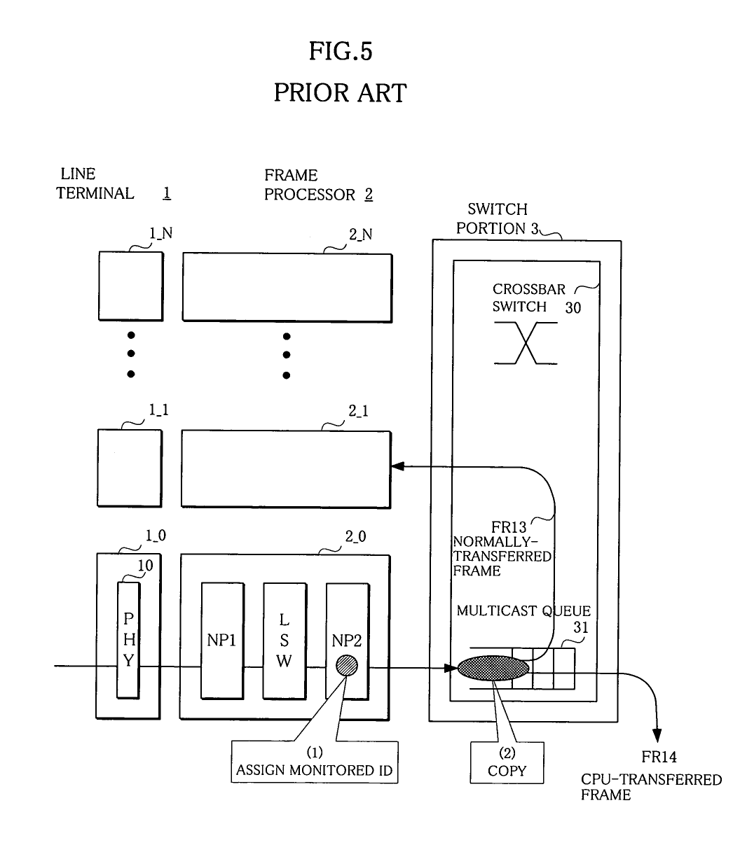

FIG. 6 is a diagram showing a prior art generation process of frame information; and

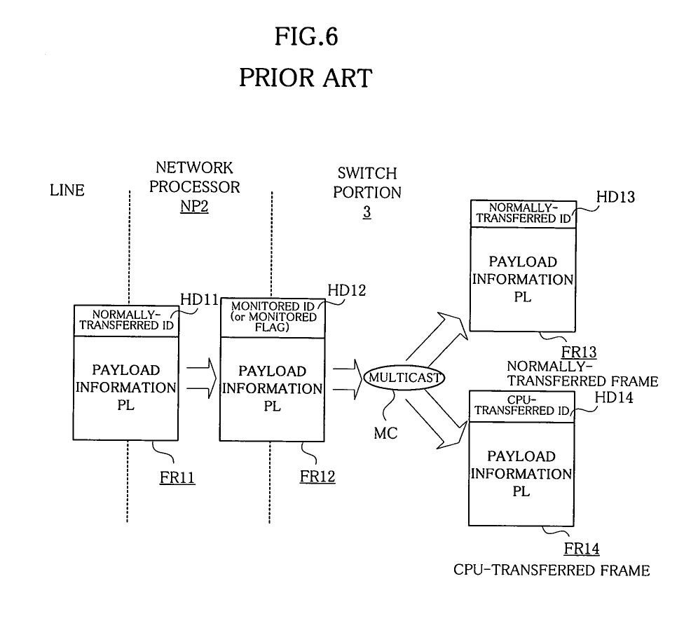

FIG. 7 is a block diagram showing a prior art example (2) of a method and an apparatus for frame transfer.

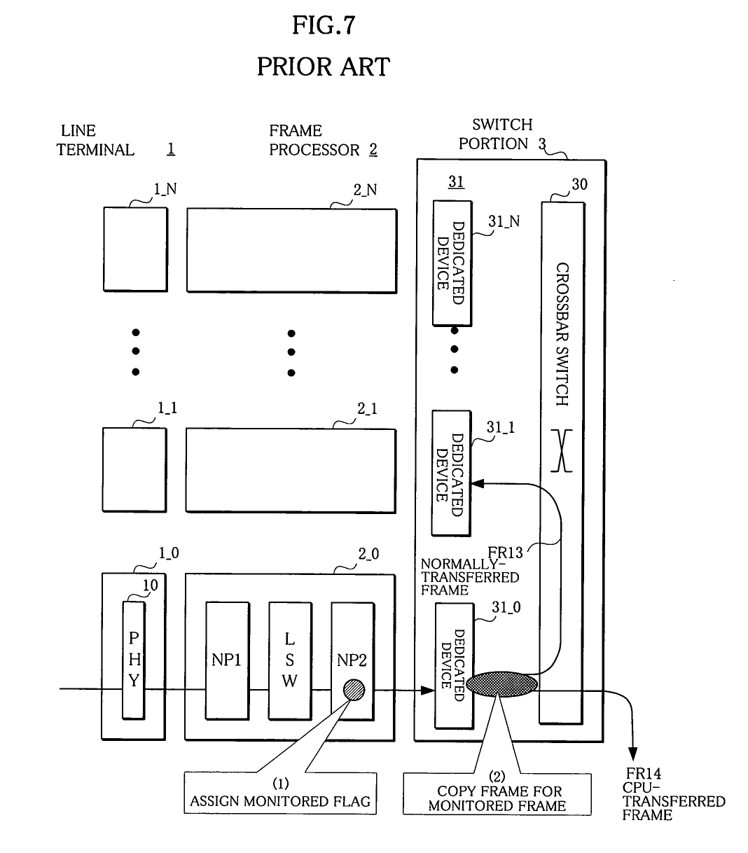

### DESCRIPTION OF THE EMBODIMENTS

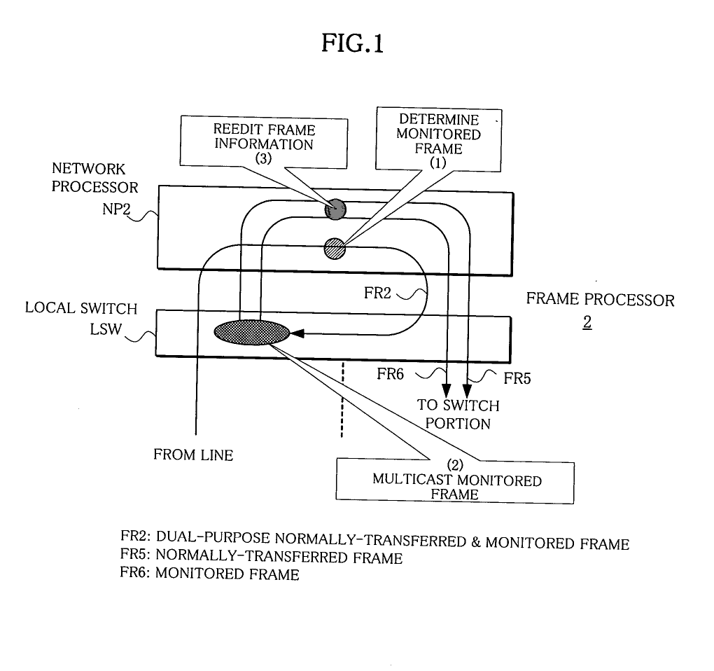

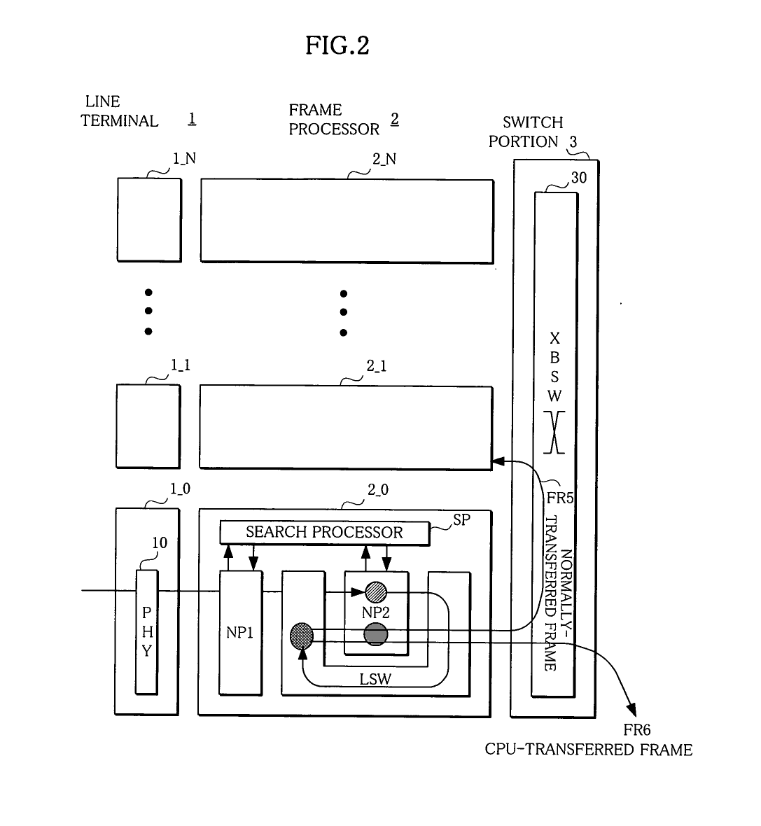

FIG. 2 shows an embodiment of a frame transfer apparatus according to the present invention, in which the schematic diagram shown in FIG. 1 is included in the frame processor 2.

Namely, each of the packet processors 2_0-2_N respectively has the network processor NP1, the local switch LSW, the network processor NP2, and the search processor SP, where the network processors NP1 and NP2 are respectively connected to the search processor SP mutually.

Also, the local switch LSW is configured such that the local switch LSW transmits a frame from the network processor NP1 to the network processor NP2, re-captures an output frame of the network processor NP2 for fixed processing, and then transmits the outputted frame to a crossbar switch 30 in a switch portion 3 through the network processor NP2 again.

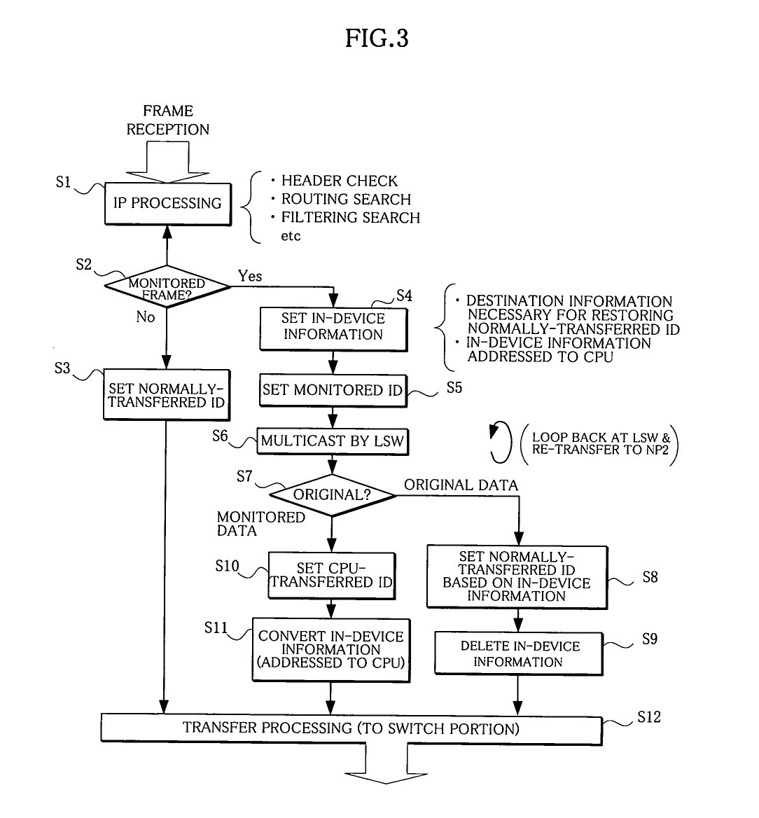

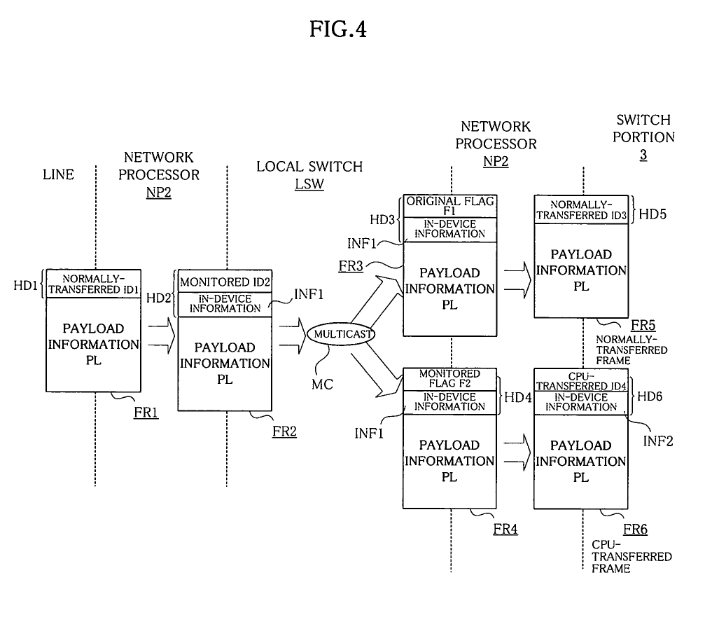

The operation of the embodiment of the present invention in FIG. 2 will now be described referring to a flow chart shown in FIG. 3 and a generation process of frame information shown in FIG. 4.

Firstly, a frame received from a line is transmitted, in the same way as the prior art examples (1) and (2), to the network processor NP1 in the frame processor 2_0 through a physical layer processor 10 in a line terminal 1_0.

Then, the network processor NP1 performs, also in the same way as the prior art examples (1) and (2), the L2 processing by transmitting/receiving signals respectively to/from the search processor SP and provides a frame FR1 (header information HD1 of normally-transferred ID1+payload information PL) to the local switch LSW. The local switch LSW once buffers the received frame FR1 to be transmitted to the network processor NP2.

In the network processor NP2, as shown by step S1 of FIG. 3, normal IP processing (header check/change processing, routing search processing, and filtering search processing) is performed to the frame FR1 in cooperation with the search processor SP.

After this operation, the network processor NP2 determines whether or not the received frame is to be monitored (at step S2). In this case, whether or not the frame is to be monitored has only to be determined by whether or not a destination address included in the header information of the received frame is a predetermined address of a monitored frame.

As a result, if the received frame FR1 is not to be monitored, the normally-transferred ID of the header information HD1 in the frame is rewritten into a new normally-transferred ID so that the frame may pass through a predetermined path (connection) of the switch portion 3 and the frame processor 2_1 (at step S3), and the frame is transferred to the switch portion 3 to be processed (at step S12).

If it is found at step S2 that the frame FR1 is to be monitored, the network processor NP2 generates a frame FR2 in which the header information HD1 is rewritten into header information HD2.

Namely, as shown in FIG. 4, in-device information INF1 is firstly set in the header information HD2 (at step S4). This includes information (destination information) necessary for restoring the normally-transferred ID1 and the in-device information transferred to the CPU for monitoring.

Furthermore, the network processor NP2 sets a monitored ID (at step S5). Accordingly, the network processor NP2 generates, with the header information HD2, the dual-purpose normally-transferred and monitored frame FR2.

Thus, in the first processing of the network processor NP2, normal IP processing is performed to the frame FR1 received from the line, the in-device information necessary for normal transferring or for transferring to the CPU is assigned to the frame as determined to be monitored, and the frame is transferred to a loopback flow of the local switch LSW.

When the frame FR2 is looped back from the network processor NP2 to the local switch LSW in this way, this local switch LSW copies the frame by multicast processing MC (at step S6).

This multicast processing MC generates frames FR3 and FR4. The local switch LSW multicasts the frame FR2 by separating into the original frame FR3 and the monitored frame FR4 (at step S7).

Namely, in case of the frame FR3, only a monitored ID2 in the header information HD3 is rewritten into an original flag F1 as original data. In case of the frame FR4, only a monitored ID2 in the header information HD4 is rewritten into a monitored flag F2 as monitored data. It is to be noted that the in-device information is left unchanged.

Thus, in the local switch LSW, the dual-purpose normally-transferred and monitored frame FR2 looped back from the network processor NP2 is copied by the multicasting function of the local switch LSW. The normally-transferred (original) header information HD3 and the monitored (addressed to CPU) header information HD4 are respectively assigned to the copied two frames FR3 and FR4 to be re-transferred to the network processor NP2.

Then, the frames FR3 and FR4 are re-transferred to the network processor NP2. In case of the frame FR3, a normally-transferred ID3 is set for header information HD5 based on the in-device information INF1 as the original data (at step S8), and the in-device information INF1 is deleted (at step S9). It is to be noted that the normally-transferred ID3 is the normally-transferred ID1 of the frame FR1 re-set to the path in the switch portion 3 and the frame processor 2_1, based on the in-device information INF1.

On the other hand, in case of the frame FR4, a CPU-transferred ID4 is set in header information HD6 as the monitored data (at step S10), and in-device information INF2 is substituted for the in-device information INF1 (at step S11). This in-device information INF2 is the in-device information INF1 from which the destination information, for restoring the normally-transferred ID1 as set at step S4, is removed.

Thus, in the second processing of the network processor NP2, the original frame FR3, which is one of the frames FR3 and FR4 re-transferred from the local switch LSW, is determined to be normally transferred, and extra information assigned for loopback of the local switch LSW is deleted. Then, this frame FR3 is reedited as the frame FR5 having the same format as the normally-transferred frame. Also, the frame FR4 determined to be CPU-addressed is made a frame FR6 in which information necessary for being CPU-addressed is extracted from the frame.

Thus, the normally-transferred frame FR5 and the CPU-transferred frame FR6 generated at the network processor NP2 are transmitted to the switch portion 3 (at step S12). At the crossbar switch 30 in the switch portion 3, the normally-transferred frame FR5 is transmitted to the frame processor 2_1, and the CPU-transferred frame FR6 is transmitted to a predetermined CPU from the crossbar switch 30.

As described above, a method and an apparatus for frame transfer according to the present invention are arranged such that a monitored frame having unique in-device information and a normally-transferred frame are generated from a received frame, and a path is established corresponding to each of the generated frames. Therefore, it becomes possible to flexibly set respective in-device information to the monitored frame and the normally-transferred frame.

Also, the same local switch is arranged on both sides of a network processor, a monitoring function is realized by looping back a frame determined to be monitored in the network processor to the network processor through the local switch, and two frames looped back to the network processor are respectively processed into the normally-monitored frame and the CPU-transferred frame and are transferred to the switch portion. Therefore, it becomes unnecessary to mount a dedicated device for copying.

Furthermore, a frame to which the required minimum in-device information is assigned is transferred to the local switch, whereby it becomes unnecessary to perform repeated processing such as search, and it becomes possible to flexibly set frames upon editing frames.

Since the monitored frame and the normally-transferred frame are separately transferred to the switch portion at the subsequent stage, it becomes possible for the switch portion to perform frame transfer processing of unicast/multicast without awareness that the frame is to be monitored, and it becomes easy to manage the connection.

What we claim is:

1. A frame transfer method comprising:
a first step of generating, from a received frame, a monitored frame having unique in-device information and a normally-transferred frame; and
a second step of establishing a path corresponding to each of the generated frames.

2. The frame transfer method as claimed in claim 1 wherein the first step comprises a third step of determining whether or not the received frame is to be monitored and of generating, from the received frame, a dual-purpose normally-transferred and monitored frame, and a fourth step of generating, from the dual-purpose frame, the monitored frame and the normally-transferred frame.

3. The frame transfer method as claimed in claim 2 wherein the third step includes steps of determining whether or not the received frame is to be monitored, and generating the dual-purpose frame in which predetermined header information is substituted for header information of the received frame when determining that the received frame is to be monitored, and the fourth step includes steps of multicasting the dual-purpose frame to be outputted by editing header information of one of the multicasted frames for normal transferring and header information of the other frame for monitoring, and further editing both of the multicasted frames with header information respectively corresponding thereto for the second step.

4. The frame transfer method as claimed in claim 3 wherein the predetermined header information of the dual-purpose frame includes a monitored ID as well as information necessary for restoring a normally-transferred ID and information used for monitoring, and the fourth step includes steps of generating two frames in which the monitored ID of the dual-purpose frame is rewritten into an original flag and a monitored flag upon the multicasting, and further generating the normally-transferred frame and the monitored frame respectively by restoring a normally-transferred ID for header information of the frame having the original flag and rewriting header information of the frame having the monitored flag into a CPU-transferred ID.

5. The frame transfer method as claimed in claim 2 wherein the third step includes a step of determining that the received frame is to be monitored based on a destination address in header information of the received frame.

6. A frame transfer apparatus comprising:
a frame processor for generating, from a received frame, a monitored frame having unique in-device information and a normally-transferred frame; and
a switch portion for establishing a path corresponding to each of the generated frames by inputting the frames.

7. The frame transfer apparatus as claimed in claim 6 wherein the frame processor comprises a network processor for determining whether or not the received frame is to be monitored and for generating, from the received frame, a dual-purpose normally-transferred and monitored frame, and a local switch for generating in cooperation with the network processor, from the dual-purpose frame, the monitored frame and the normally-transferred frame to be transmitted to the switch portion.

8. The frame transfer apparatus as claimed in claim 7 wherein the network processor determines whether or not the received frame is to be monitored, and generates the dual-purpose frame in which predetermined header information is substituted for header information of the received frame when determining that the received frame is to be monitored, and the local switch multicasts the dual-purpose frame to be outputted to the network processor by editing header information of one of the multicasted frames for normal transferring and header information of the other frame for monitoring, and the network processor edits both of the frames with header information respectively corresponding thereto to be transmitted to the switch portion.

9. The frame transfer apparatus as claimed in claim 8 wherein the predetermined header information of the dual-purpose frame includes a monitored ID as well as information necessary for restoring a normally-transferred ID and information used for monitoring, and the local switch generates two frames in which the monitored ID of the dual-purpose frame is rewritten into an original flag and a monitored flag upon the multicasting, and the network processor generates the normally-transferred frame and the monitored frame respectively by restoring a normally-transferred ID for header information of the frame having the original flag and rewriting header information of the frame having the monitored flag into a CPU-transferred ID.

10. The frame transfer apparatus as claimed in claim 7 wherein the network processor determines that the received frame is to be monitored based on a destination address in header information of the received frame.
